(19) United States
(12) Patent Application Publication
(10) Pub. No.: US 2022/0414862 A1
(43) Pub. Date: Dec. 29, 2022

(54) METHOD FOR CREATING A DIGITAL TWIN OF AN INFRASTRUCTURE COMPONENT

(71) Applicant: Stupp Bros., Inc., St. Louis, MO (US)

(72) Inventors: Mark Strong, Zachary, LA (US); John Clark, Richmond, TX (US); Dave Toups, Houston, TX (US); Inderjeet Singh, Zachary, LA (US)

(21) Appl. No.: 17/505,311

(22) Filed: Oct. 19, 2021

Related U.S. Application Data
(60) Provisional application No. 63/215,065, filed on Jun. 25, 2021.

(51) Int. Cl. G06T 7/00; G06T 17/10; G06T 7/586; G06T 7/62; G06K 9/00; G01N 21/952; G01N 21/954; G01B 15/02

(52) U.S. Cl. CPC G06T 7/0006; G06T 17/10; G06T 7/586; G06T 7/62; G06K 9/00637; G01N 21/952; G01N 21/954; G01B 15/025; G06T 2207/10116; G06T 2207/30164; G06T 2207/30184; G06K 2209/19

(57) ABSTRACT

Systems and methods for creating a digital twin of an infrastructure component. The digital twin is a computerized, three-dimensional model of the component, typically a pipe, created after manufacture but before installation. The digital twin can be saved on a computer-readable storage medium for later retrieval, and can be loaded into three-dimensional modeling software for manipulation and viewing from various angles and perspectives. The twin is created from a plurality of imaging systems capturing different surfaces or different aspects, whose measurements are mapped to a uniform coordinate system to generate a three-dimensional model. Other data may also be added to or stored with the digital twin, such as manufacturing specifications, photographic data, and current or historical inspection data. The digital twin may be viewed on a mobile device programmed to receive, display, and allow the user to view and manipulate the digital twin.

### CROSS-REFERENCE TO RELATED APPLICATIONS

This application claims the benefit of U.S. Prov. Pat. App. No. 63/215,065, filed Jun. 25, 2021, the entire disclosure of which is incorporated herein by reference.

### BACKGROUND OF THE INVENTION

### Field of the Invention

This disclosure is related to the field of computer imaging, and more particularly to systems and methods for combining multiple independent imaging systems to create and utilize a digital twin of an infrastructure component.

### Description of the Related Art

A great deal of civil infrastructure depends on the use of pipes or piping, notably for the conveyance of fluids. Pipes are used in a wide variety of industries, from plumbing to irrigation to petroleum and natural gas. The types, dimensions, and composition of pipes for a given application depends on the needs, notably the type of fluid or other substance being conveyed in the pipe. Likewise, the location and placement of the pipe will vary from case to case. Some pipes are installed above ground or elevated upon a support system, but most infrastructure pipes are buried underground.

Burying pipes has a number of advantages, including that they are protected from tampering and weather, out of the way of other infrastructure, and out of sight. However, burying pipes also has downsides. The ground beneath our feet is not static and unmoving. The composition, structure, and properties of soil change over time due to various factors, including both natural geologic processes and human activity. This can cause pipes to move, resulting in damage or leaks, which can require excavation to investigate, assess, and repair. The process of identifying the potentially compromised portion of a buried pipe, and of excavating it for inspection, is expensive, disruptive, and hazardous. If the pipe is not actually compromised, the process is also wasteful.

A number of technologies have been used to examine subterranean pipes for flaws. One common technique is the use of a pipeline inspection gauge, known in the art as a “pig,” which may be inserted into a pipe and traverse some or all of its length to inspect the interior for signs of damage or other sources of potential failure. Pigging systems are also used for various pipe maintenance tasks, such as cleaning.

Pigs may include a variety of onboard instrumentation to collect data while traversing the pipeline. Typically, a pig is unable to communicate with the outside world during a run, due to a combination of the long distance traveled and the environment within the pipe. Pipe materials usually inhibit radio transmission outside of the pipe environment, and the pig thus typically uses onboard storage to record the data collected during the run. After the pig is extracted, this information may be analyzed to identify the location and nature of any potential problems with the pipe.

Unfortunately, this data is often ambiguous, and it can be difficult to distinguish a structural problem that could lead to failure from harmless conditions, such as surface flaws or blemishes, which do not compromise the structural integrity of the pipe, nor its suitability for continued operational use. Thus, pig data could indicate the need for servicing, but excavation and inspection could show that the pipe is within specifications and may continue to be used. Accordingly, what is needed in the art are systems and methods to determine whether a detected anomaly with a buried pipe merits further investigation without the need to excavate.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a method for creating a digital twin of an pipe comprising: providing a computer server communicably coupled to a telecommunications network; manufacturing a pipe having an exterior surface and an opposing interior surface; before installing the pipe: using a first imaging system, scanning the exterior surface to collect a first set of image data about the exterior surface, the first set of image data comprising locations of physical characteristics of the exterior surface in a first coordinate system; using a second imaging system, scanning the interior surface to collect a second set of image data about the interior surface, the second set of image data comprising locations of physical characteristics of the interior surface in a second coordinate system; receiving, at the computer server, the first set of image data and the second set of image data; creating, at the computer server, a digital twin of the pipe, the digital twin based on the received first set of image data and the received second set of image data and created at least in part by mapping the first coordinate system and the second coordinate system to a single coordinate system to generate a three-dimensional model of the scanned pipe; storing the digital twin in a computer-readable storage medium of the computer server; installing the pipe; using a pipe inspection gauge, inspecting the installed pipe; during the inspecting, the pipe inspection gauge collecting inspection data comprising locations of physical characteristics of the pipe; identifying, in the inspection data, a physical characteristic indicative of a structural flaw in the pipe; determining whether the location of the physical characteristic indicative of a structural flaw is also indicated in the digital twin by comparing the inspection data at the location to the digital twin at the location; and updating the digital twin with the inspection data.

In an embodiment of the method, the pipe comprises a pipe segment.

In another embodiment of the method, the first imaging system comprises an outer diameter profiling system and the second imaging system comprises an inner diameter profiling system.

In another embodiment of the method, the outer diameter profiling system comprises a laser profiler and the inner diameter profiling system comprises a laser profiler.

In another embodiment of the method, the method further comprises: before installing the pipe: using a thickness profiling system, scanning the pipe to collect a second set of thickness data about the thicknesses of the pipe at a plurality of locations on the pipe in a third coordinate system; receiving, at the computer server, the set of thickness data; the creating, at the computer server, the digital twin of the pipe further comprising creating the digital twin based on the received set of thickness data and at least in part by mapping the third coordinate system to the single coordinate system.

In another embodiment of the method, the thickness profiling system comprises an X-ray profiler having an X-ray source and an X-ray receiver.

In another embodiment of the method, the mapping the first coordinate system, the second coordinate system, and the third coordinate system to a single coordinate system comprises, at the computer server: selecting, from among the first coordinate system, the second coordinate system, and the third coordinate system, a reference coordinate system to be the single coordinate system; selecting, in the reference coordinate system, a reference location on the pipe; identifying in each of the first coordinate system, the second coordinate system, and the third coordinate system not selected to be the reference coordinate system a reference point corresponding to the selected reference point in the reference coordinate system; and using the reference point on the pipe and each of the corresponding reference points, mapping each of the data sets for the unselected coordinate systems into the reference coordinate system.

In another embodiment of the method, the scanning the interior surface comprises: disposing the second imaging system at a distal end of a boom; inserting the distal end into the pipe; and during the inserting, rotating the second imaging system to scan the interior surface of the pipe.

In another embodiment of the method, the scanning the interior surface comprises: disposing the second imaging system at a distal end of a boom; inserting the distal end into the pipe; and during the inserting, rotating the pipe, second imaging system scanning the interior surface of the rotating pipe.

In another embodiment of the method, the method further comprises: before installing the pipe: using a photographic imaging system, scanning the pipe to collect a set of photographic data indicative of the visual appearance of the pipe prior to installation; receiving, at the computer server, the set of photographic data; and storing, with the digital twin, the received photographic data.

In another embodiment of the method, the method further comprises: storing, with the digital twin, manufacturing specifications for the pipe.

In another embodiment of the method, the method further comprises: repeating the inspecting, collecting, identifying, determining, and updating steps a plurality of times.

In another embodiment of the method, the repeating is performed in accordance with a maintenance schedule for the pipe.

In another embodiment of the method, the method further comprises: creating, at said computer server, an inspection history record for the pipe comprising each set of inspection data collected during each of the plurality of repeating the inspecting, collecting, identifying, determining, and updating.

In another embodiment of the method, the method further comprises: displaying a visualization of the digital twin on a computer display.

In another embodiment of the method, the method further comprises: displaying, with the displayed digital twin, a visual indication of the inspection history record.

In another embodiment of the method, the method further comprises: displaying, with the displayed digital twin, a visualization of the manufacturing specifications.

In another embodiment of the method, the method further comprises: displaying, on the displayed digital twin, a location on the pipe of the detected physical characteristic indicative of a structural flaw.

In another embodiment of the method, the method further comprises: displaying, on the displayed digital twin, at the displayed location, a visualization of the detected physical characteristic indicative of a structural flaw.

In another embodiment of the method, the display is a display is a mobile device and the digital twin is received at the mobile device from the computer server via the telecommunications network

[symbol]

### BRIEF DESCRIPTION OF THE DRAWINGS

FIG. 1A depicts a top down schematic view of a system for creating a digital twin of an infrastructure component according to the present disclosure.

FIG. 1B depicts a side elevation schematic view of the embodiment of FIG. 1A.

FIG. 2 depicts an embodiment of a digital twin of an infrastructure component according to the present disclosure.

FIG. 3 depicts an embodiment of a system for using a digital twin of an infrastructure component according to the present disclosure.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein, among other things, are systems and methods for creating a “digital twin” of an infrastructure component. The digital twin is a computerized, three-dimensional model of the pipe created after manufacture but before installation. The digital twin can be saved on a computer-readable storage medium for later retrieval, and can be loaded into three-dimensional modeling software for manipulation and viewing from various angles and perspectives.

Unlike a traditional computer-aided drafting system, where a product is first generically modeled in a computer and then physical embodiments are later produced, here, a model is created of a specific produced embodiment. Thus, the digital twin of any two pipes, even if produced from identical specifications, may differ based on actual differences between the two embodiments after manufacture.

The digital twin captures data and information about the physical condition and appearance of the infrastructure component upon manufacture. This information is stored and/or archived in a computer-readable storage medium for later retrieval after the infrastructure component has been installed. The digital twin can then serve as a reference for assessing inspection data (such as that acquired by a pig, or similar pipe inspection technology) to help determine whether detected anomalies merit further investigation and/or remediation. For example, if the anomalous data matches the digital twin and corresponds to a harmless surface blemish, and the component was within specifications at manufacture, it can be reasonable inferred that the anomaly is not indicative of a defect or risk of failure. These and other aspects are described in further detail elsewhere herein.

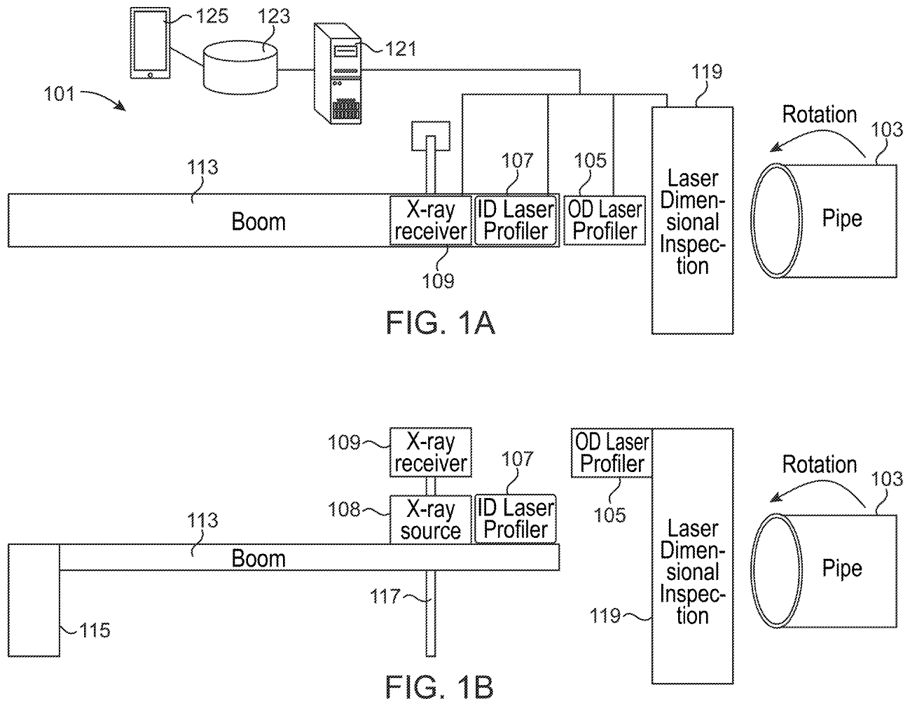

The components of the systems and methods are shown at a high level of abstraction in the non-limiting embodiments of FIGS. 1A and 1B. A first element of the depicted systems and methods is that an infrastructure component is subjected to one or more imaging processes, or a series or sequence of imaging processes. In the depicted embodiment, the infrastructure component is a pipe (103) and an embodiment using pipe is described throughout this disclosure, but this is not necessarily limiting and the systems and methods could be applied to other infrastructure components.

In an embodiment, the imaging processes may be carried out simultaneously, or in an ordered sequence, or in a combination. The result of the imaging processes is that data representative of the physical condition of the pipe (103) shortly after the manufacturing process, but before the pipe (103) is installed, is acquired and may be stored in a database (123), separately or in combination.

The different imaging processes may result in a plurality of different image data sets and/or different formats. These are harmonized and unified into a single data set. This may be done by use of specially programmed computer software on a computer system (112), which receives the various data sets and combines them. For example, the various data sets may be modified if and as necessary for mapping onto a single coordinate system in a three-dimensional modeling software system. The resulting three-dimensional model comprising the combined data sets can be thought of as the digital twin (201), though other data may be added to or combined with the image data to augment the digital twin (201). The digital twin (201) may then be stored, archived, copied, and shared for later manipulation and viewing on a display, such as that of a mobile device (125), or other computer display.

Once the digital twin (201) has been captured, the pipe (103) may then be installed and used in an infrastructure project, and the digital twin (201) can be compared with inspection data to provide additional operational intelligence for decision-making. For example, once the pipe (103) has been buried, if an inspection later collects inspection data that is indicative of a potential problem or anomaly, the anomaly data may then be compared to the digital twin (201) of the particular pipe (103) for analysis. For example, suppose the data indicates a surface anomaly 9 inches long, observed 30 feet from the end of the pipe (103) and located at the three o-clock positions (i.e., 90 degrees to the right from vertical). The digital twin (201) can be loaded into memory for viewing in three-dimensional modeling software, and the section of the digital twin (201) at that location can be visually examined to determine whether an anomaly at that location was observed during the initial imaging. If so, the digital twin (201) may be compared with the anomaly data to determine whether they match. That is, the digital twin (201) may likewise show that a similarly sized and shaped anomaly in the same location was identified after manufacture and determined to be a harmless surface blemish within specifications. Thus, the detected anomaly does not indicate a defect or potential source of failure, and no remediation is needed. However, if the analysis determines that the anomaly was not present at manufacturing, or has since changed; further investigation may proceed, such as excavation and physical inspection.

In an embodiment, one or more sets of inspection data, which may include anomaly data, may be included in a copy of the digital twin (201) to update the model. For example, if a pig retrieves information about additional anomalies not found during the initial imaging scan, or new data about anomalies that were found, this new data may be added to the digital twin (201), which can then be kept current over time. In an embodiment, this anomaly data may be used to update the visualization of the model, thereby providing a visualization of the detected anomaly. In another embodiment, the data may be separately viewing or accessible via the digital twin (201). This facilitates the use of the digital twin (201) in an evergreen fashion, with continued updates over time as additional inspection and/or anomaly data is collected about the infrastructure component (103) represented by the digital twin (201). Over time, an historical archive of data about the infrastructure component (103) is collected and stored. The detected status at any given point on time can be retrieved and viewed, providing a historical archive tracking the changes to the pipe (103) over time.

Thus, if a subsequent inspection again detects the same anomaly, the digital twin (201) can be consulted to determine that the anomaly was previously found, and what decisions were made. Likewise, if a subsequent investigation identifies the same anomaly, but determines that it has changed in some fashion, this may be indicative of a problem that requires further investigation.

Over time, the historical archive will provide a “version history” of the pipe (103) via the digital twin (201). Various dates associated with the pipe (103) and/or specific investigations and/or anomalies may be included with the digital twin (201). For example, even if an investigation reveals no potential issues, the resulting data set, and other data about the investigation may be stored in or in association with the digital twin (201).

This supplementary information can be indicated visually in the three-dimensional modeling software for viewing the digital twin (201), providing access to the history of investigations of a given pipe (103), including the dates and/or times when maintenance and/or inspections were performed, what equipment was used, who performed it, what data was collected, what anomalies were detected, who analyzed the inspection and/or anomaly data, and so forth. This provides on-site operational intelligence and assist with decision-making as to whether to further investigate or excavate a given pipe (103).

FIGS. 1A and 1B depict various systems that may be used to conduct the initial imaging of the pipe (103) to create the first version of the digital twin (201) for a given component. As shown in the figures, a pipe (103) may be imaged using one or more imaging systems. In the depicted embodiment, a plurality of imaging systems are shown, including an inner diameter profiling system (107), an outer diameter profiling system (105), and a thickness profiling system (108) and (109).

In the depicted embodiment, the inner diameter profiling system comprises a laser profiler (107). In such an embodiment, a scan of the interior surface of the pipe (103) is conducted by placing the inner diameter profiling system (107) on a boom (113), which is then inserted into the pipe (103). The pipe (103) can then be is rotated while the boom (113) is inserted, allowing the inner diameter profiling system (107) to conduct a complete scan the interior surface of the pipe (103). The pipe (103) may be rotated using any technique known in the art such as by placing it on a roller bed. Likewise, the boom (113) may be inserted into the pipe (103), or the pipe (103) may be moved laterally to surround the boom (113). In an alternate embodiment, the inner diameter profiling system (107) may be rotated, such as by the placing the inner diameter profiling system (107) on a rotatable component at the end of the boom (113), or by rotating some or all of the boom (113) itself. The data resulting from the inner diameter profiling system (107) may then be stored, such as on a computer-readable storage medium, such as in a database (123), and/or may be transmitted to a computer (121) for storage, such as in a database (123). As also described elsewhere herein, this data is later combined with other data from other imaging systems to create the digital twin (201).

In the depicted embodiment of FIGS. 1A and 1B, an outer diameter profiling system (119) is provided for conducting a scan of the outer surface area of the pipe (103). In the depicted embodiment, this is also a laser profiler (119). In the depicted embodiment, the outer diameter profiling system (119) is disposed above, or outside, the outer surface of the pipe (103). As with the inner scan, the pipe (103) may be rotated at its central axis and gradually moved past the outer diameter profiling system (119), or the profiler (119) may be rotated and/or moved along the length of the pipe (103), to conduct a complete scan of the exterior surface of the pipe (103). The data resulting from the outer diameter profiling system (119) may then be stored, such as on a computer-readable storage medium, such as in a database (123), and/or may be transmitted to a computer (121) for storage, such as in a database (123). As also described elsewhere herein, this data is later combined with other data from other imaging systems to create the digital twin (201).

Also shown in the depicted embodiment, a thickness profiling system may be used to collect data about the thickness of the pipe (103). The inner and outer diameter scans provide data about the contour, shape, and appearance of the interior and exterior surfaces of the pipe (103), respectively, but these two measures, independently, may not be sufficient to determine the thickness of the pipe (103) at any given point. Thus, a thickness profiling system may be included as one of the plurality of imaging systems in an embodiment. In the depicted embodiment, the thickness profiling system comprises an X-ray source (108) and an X-ray receiver (109) used in concert to measure the thickness of the pipe (103). Again, this may be done by rotating the pipe (103) and gradually moving it between the source (108) and receiver (109) so that the thickness of the pipe (103) is measured along its full length and circumference. The data resulting from the thickness profiling system may then be stored, such as on a computer-readable storage medium, such as in a database (123), and/or may be transmitted to a computer (121) for storage, such as in a database (123). As also described elsewhere herein, this data is later combined with other data from other imaging systems to create the digital twin (201). Although. the depicted embodiment shows an X-ray system, other systems are known in the art and may be used, including, but not necessarily limited to, an ultrasound imaging system.

Other imaging systems may also be used. By way of example and not limitation, photographic data may be collected about the visual appearance of the interior and/or exterior surfaces of the pipe. Whereas the laser profilers collect data about the three-dimensional shape and configuration of the pipe (103), a photographic system may be used to collect purely aesthetic information. This would allow the digital twin (201) to model not only contours but also purely aesthetic features, which might not be detected by a laser profiler, such as color. Again, the data resulting from the photographic imaging system may then be stored, such as on a computer-readable storage medium, such as in a database (123), and/or may be transmitted to a computer (121) for storage, such as in a database (123). As also described elsewhere herein, this data is later combined with other data from other imaging systems to create the digital twin (201). Although the depicted embodiment shows an X-ray system, other systems are known in the art and may be used, including, but not necessarily limited to, an ultrasound imaging system.

The data resulting from the imaging scans may then be combined into a unified three-dimensional model of the pipe (103). In an embodiment, this process may involve selecting a reference coordinate system and reference point on the pipe (103), and then mapping each image data set into the reference coordinate system using the pipe reference point to provide spatial consistency among the plurality of data sets. This process may include the use of certain data about the dimensions of the pipe, and/or the location of the imaging systems with reference thereto. By way of example and not limitation, if the outer diameter scan detects a blemish on the surface, the dimensions of the blemish may be determined with reference to data about distance between the profiler (105) and the pipe (103) during the scan. Likewise, the modeling software can conduct consistency checks of the data. The photographic data may likewise be mapped onto the surfaces.

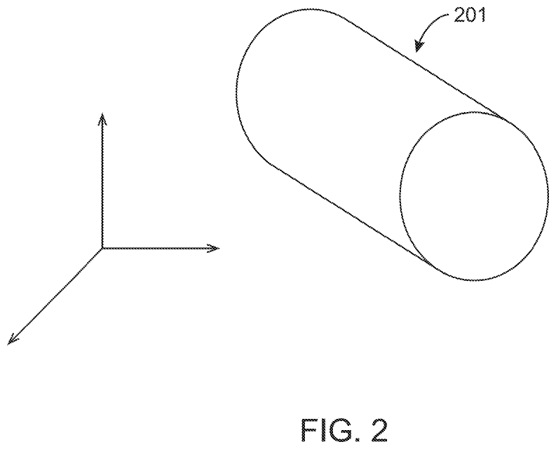

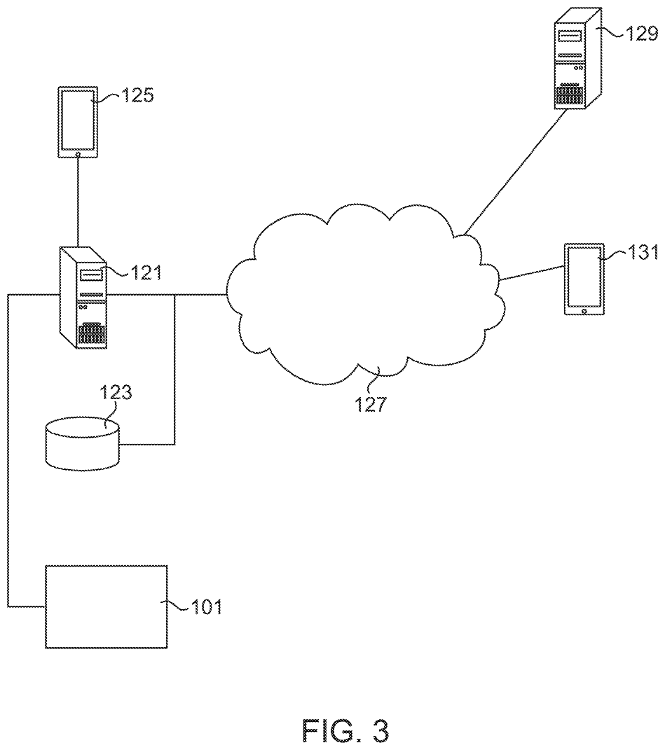

Once the various sets of image data have been collected and combined into the digital twin (201), in certain embodiments, the digital twin can be rendered in three-dimensional modeling software and manipulated therein. An embodiment of such a display is depicted in FIG. 2. The digital twin (201) may be rotated, viewed, panned, zoomed, and other such operations performed using the three-dimensional modeling software. Additionally, the camera in the three-dimensional modeling software can be placed inside of the digital twin (201) to conduct a more thorough examination of the interior surface, which, particularly for small-diameter pipes, may be difficult or impossible to conduct in reality. The digital twin (201) may be inspected and compared with the pipe (103) in question to confirm that the process produced an accurate representation.

It should be noted that although it may be possible to display and render the digital twin in a three-modeling software program, in certain embodiments, this may not be necessary. The digital twin is the underlying data itself, which represents a three-dimensional model of the pipe, but at least some, and possibly all, of the data collected may not necessarily be amenable to a visualization or rendering. Thus, references in this disclosure to examining, analyzing, reviewing, comparing, and performing other operations relative to the digital twin do not necessarily require that a rendering be produced as shown in FIG. 2, but may instead comprise a different type of analysis, such as of the underlying data itself as compared to inspection and/or anomaly data.

In an embodiment, the digital twin (201) may include other data as well. By way of example, data about the specific pipe (103) represented by the digital twin (201) may be included, such as, but not necessarily limited to, the date of the pipe's (103) manufacture, the date of each scan, the scanning equipment used, the persons conducting the scan and/or visual inspection to confirm accuracy, and so forth. This information may be useful to retrieve later if questions arise about the accuracy of the digital twin (201), or of the scanning process to help troubleshoot any anomalies found later.

The digital twin (201) may be stored in a database (123) in association with a unique identifier, such as (but not necessarily limited to) a serial number, associated with the specific pipe (103) that was imaged to produce it (201). This allows the digital twin (201) for a specific pipe (103) to be later located and viewed after the pipe (103) is buried. The pipe (103) may then be shipped for installation.

To view the digital twin (201) in the field or otherwise after installation, software may be used to access and view the digital twin (201) on a mobile device or other computer remote from the manufacturing and/or imaging center. This software can be provided the unique identifier for the pipe (103), which is used to search the database for, and retrieve, a copy of the digital twin. (201) for that pipe. This in turn requires that the unique identifier for a given pipe is known. This may be done by simply documenting the unique identifiers for each pipe (103) segment as it is installed and consulting with the documentation, but other techniques may also be used. For example, the unique identifier or a representation of it may be engraved or stamped on an interior surface of the pipe, so that when a pig later enters the pipe segment in question, it can scan or detect the unique identifier and store it in association with the inspection data. Other techniques could also be used, such as by embedding or placing a radio frequency identification (RFID) tag within the pipe and equipping the pig with an RFID scanner.

In an embodiment, the database (123), or a copy or subset of it, may be made available via a network (127) for browsing and searching. For example, a mobile device (131), desktop computer (129), or other computing device may connect to the database (123) over a network (127), and to access the database (123) and search for digital twins (201) for pipes that were installed or managed. This may involve the use of a software application on the client computer systems (129) or (131), or a software-as-a-service application in which the software is on the remote server computer (121) and is accessed by the client devices (129) or (131). Alternately, a copy of the digital twin (201) may simply be provided on a computer readable storage medium to the purchaser or installer or maintainer of the pipe (103), and is loaded locally without the need to use a network connection (127). This may be desirable in environments where pipelines are installed in remote locations with unreliable access to network surfaces.

After an inspection of a pipe (103), the resulting data collected by the pig may then be compared with the digital twin (201) to determine whether any anomalies detected by the pig are manufacturing defects, or damage which requires remediation, or mere surface blemishes not indicative of a defect or damage. A decision of whether to conduct further investigation_{;} such as by running additional pigs, or excavating a pipe (103), may then be made. The resulting inspection and/or anomaly data, and/or the decisions made with respect thereto, may then be entered into a client computer (129) and/or (131) and/or may be provided to the database (123) housing the original digital twin (201) and used to supplement the digital twin (201) with an updated version of the pipe (103) as described elsewhere herein.

Additionally, the digital twin (201) may include a copy of the specifications for the particular pipe (103), which may then also be viewed or accessed in the software. This also allows a field operator to quickly determine whether any anomalies detected are within specification, and/or whether any anomalies reflected in the digital twin (201) have been detected by the pig as having changed such that the pipe (103) is no longer within specification. In a further embodiment, the digital twin (201) modeling software may itself be programmed to analyze the data and provide an estimate as to whether the pipe (103) is within specifications. The information may also be helpful in resolving disputes over the source or cause of damage. For example, if a pipe shows signs of failure, but the digital twin (201) indicates that the pipe (103) was within specifications, the damage may be have been caused during installation, maintenance, or by natural forces, rather than a manufacturing defect.

Throughout this disclosure the term “computer” means hardware which generally implements functionality provided by digital computing technology, particularly computing functionality associated with microprocessors. The term “computer” is not intended to be limited to any specific type of computing device, but it is intended (unless otherwise qualified) to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including, but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an. enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service (SAAS), or other distributed or collaborative computer networks. Thus, to the extent this disclosure describes systems or methods as being performed by or on a computer, a person of ordinary skill in the art will understand that, unless specified otherwise, the systems and methods may be implemented on a single device or distributed across multiple devices.

Those of ordinary skill in the art also appreciate that some devices not conventionally thought of as “computers” nevertheless exhibit the characteristics of a “computer” in certain contexts. Where such a device is performing the functions of a “computer” as described herein, the term “computer” includes such devices to that extent. Devices of this type include, but are not limited to: network hardware, print servers, file servers, NAS and SAN, load balancers, IoT devices, smart devices, and other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including, without limitation, virtual processors, or by the use of run-time environments, virtual machines, and/or interpreters.

Those of ordinary skill in the art recognize that although software is traditionally stored in a non-transitory computer-readable medium and loaded into memory on demand for execution, software can also be wired or embedded into hardware, including, without limitation, onto a microchip, and still be considered “software” within the meaning of this disclosure. For purposes of this disclosure, software includes, without limitation: instructions stored or storable in hard drives, RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including, but not necessarily limited to, a network socket connection. Those having ordinary skill in the art will further appreciate that a “server” may comprise a plurality of software and/or hardware servers delivering a service or set of services as described elsewhere herein. Those having ordinary skill in the art will further appreciate that the term “host” may, in noun form, refer to an endpoint of a network communication or network (e.g., “a remote host”), or may, in verb form, refer to a server providing a service over a network (“host a website”), or an access point for a service over a network.

Throughout this disclosure, the term “mobile device” and similar terms refers to a specific type of computer, generally a personal, carried mobile communication device such as, hut not necessarily limited to, a smart phone, tablet PC, e-reader, or wearable computer such as a smart watch or fitness device, whether of general or specific purpose functionality. Generally speaking, a mobile device is network-enabled and in communication with other network-enabled devices (which may or may not be mobile devices) over one or more networks. A mobile device is usually intended to be in near-constant real-time communication with other devices over such networks while powered on.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for creating a digital twin of a pipe comprising:
providing a computer server communicably coupled to a telecommunications network;
manufacturing a pipe having an exterior surface and an opposing interior surface;
before installing said pipe:
using a first imaging system, scanning said exterior surface to collect a first set of image data about said exterior surface, said first set of image data comprising locations of physical characteristics of said exterior surface in a first coordinate system;
using a second imaging system, scanning said interior surface to collect a second set of image data about said interior surface, said second set of image data comprising locations of physical characteristics of said interior surface in a second coordinate system;
receiving, at said computer server, said first set of image data and said second set of image data;
creating, at said computer server, a digital twin of said pipe, said digital twin based on said received first set of image data and said received second set of image data and created at least in part by mapping said first coordinate system and said second coordinate system to a single coordinate system to generate a three-dimensional model of said scanned pipe;
storing said digital twin in a computer-readable storage medium of said computer server;
installing said pipe;
using a pipe inspection gauge, inspecting said installed pipe;
during said inspecting, said pipe inspection gauge collecting inspection data comprising locations of physical characteristics of said pipe;
identifying, in said inspection data, a physical characteristic indicative of a structural flaw in said pipe;
determining whether said location of said physical characteristic indicative of a structural flaw is also indicated in said digital twin by comparing said inspection data at said location to said digital twin at said location; and
updating said digital twin with said inspection data.

2. The method of claim 1, wherein said pipe comprises a pipe segment.

3. The method of claim 1, wherein said first imaging system comprises an outer diameter profiling system and said second imaging system comprises an inner diameter profiling system.

4. The method of claim 3, wherein said outer diameter profiling system comprises a laser profiler and said inner diameter prof ling system comprises a laser profiler.

5. The method of claim 4, further comprising:
before installing said pipe:
using a thickness profiling system, scanning said pipe to collect a second set of thickness data about the thicknesses of said pipe at a plurality of locations on said pipe in a third coordinate system;
receiving, at said computer server, said set of thickness data;
said creating, at said computer server, said digital twin of said pipe further comprising creating said digital twin based on said received set of thickness data and at least in part by mapping said third coordinate system to said single coordinate system.

6. The method of claim 5, wherein said thickness profiling system comprises an X-ray profiler having an X-ray source and an X-ray receiver.

7. The method of claim 5, wherein said mapping said first coordinate system, said second coordinate system, and said third coordinate system to a single coordinate system comprises, at said computer server:
selecting, from among said first coordinate system, said second coordinate system, and said third coordinate system, a reference coordinate system to be said single coordinate system;
selecting, in said reference coordinate system, a reference location on said pipe;
identifying in each of said first coordinate system, said second coordinate system, and said third coordinate system not selected to be said reference coordinate system a reference point corresponding to said selected reference point in said reference coordinate system; and
using said reference point on said pipe and each of said corresponding reference points, mapping each of said data sets for said unselected coordinate systems into the reference coordinate system.

8. The method of 7, wherein said scanning said interior surface comprises:
disposing said second imaging system at a distal end of a boom;
inserting said distal end into said pipe; and
during said inserting, rotating said second imaging system to scan said interior surface of said pipe.

9. The method of claim 7, wherein said scanning said interior surface comprises:
disposing said second imaging system at a distal end of a boom;
inserting said distal end into said pipe; and
during said inserting, rotating said pipe, second imaging system scanning said interior surface of said rotating pipe.

10. The method of claim 7, further comprising:
before installing said pipe:
using a photographic imaging system, scanning said pipe to collect a set of photographic data indicative of the visual appearance of said pipe prior to installation;
receiving, at said computer server, said set of photographic data; and
storing, with said digital twin, said received photographic data.

11. The method of claim 10, further comprising: storing, with said digital twin, manufacturing specifications for said pipe.

12. The method of claim 11, further comprising: repeating said inspecting, collecting, identifying, determining, and updating steps a plurality of times.

13. The method of claim 12, wherein said repeating is performed in accordance with a maintenance schedule for said pipe.

14. The method of claim 13, further comprising: creating, at said computer server, an inspection history record for said pipe comprising each set of inspection data collected during each of said plurality of repeating said inspecting, collecting, identifying, determining, and updating.

15. The method of claim 14, further comprising: displaying a visualization of said digital twin on a computer display.

16. The method of claim 15, further comprising: displaying, with said displayed digital twin, a visual indication of said inspection history record.

17. The method of claim 16, further comprising: displaying, with said displayed digital twin, a visualization of said manufacturing specifications.

18. The method of claim 17, further comprising: displaying, on said displayed digital twin, a location on said pipe of said detected physical characteristic indicative of a structural flaw.

19. The method of claim 18, further comprising: displaying, on said displayed digital twin, at said displayed location, a visualization of said detected physical characteristic indicative of a structural flaw.

20. The method of claim 19, wherein said display is a display is a mobile device and said digital twin is received at said mobile device from said computer server via said telecommunications network.
